(19) United States
(12) Patent Application Publication
(10) Pub. No.: US 2016/0145148 A1
(43) Pub. Date: May 26, 2016

(54) GLASS BODY FOR PRESSURE FORMING AND METHOD FOR MANUFACTURING THE SAME, AND MICROFABRICATED GLASS BODY AND METHOD FOR MANUFACTURING THE SAME

(71) Applicants: KOBE UNIVERSITY, Kobe-shi (JP); ASAHI GLASS COMPANY, LIMITED, Chiyoda-ku (JP)

(72) Inventors: Kenji IMAKITA, Kobe-shi (JP); Minoru FUJII, Kobe-shi (JP); Kenji KITAOKA, Chiyoda-ku (JP)

(73) Assignees: KOBE UNIVERSITY, Kobe-shi (JP); ASAHI GLASS COMPANY, LIMITED, Chiyoda-ku (JP)

(21) Appl. No.: 15/013,287

(22) Filed: Feb. 2, 2016

Related U.S. Application Data
(63) Continuation of application No. PCT/JP2014/071482, filed on Aug. 15, 2014.

(30) Foreign Application Priority Data
Aug. 29, 2013 (JP) 2013-178544
Jul. 14, 2014 (JP) 2014-144026

(51) Int. Cl. C03C 11/00; C03B 23/02; C03C 15/00

(52) U.S. Cl. CPC C03C 11/005; C03C 15/00; C03B 23/02

(57) ABSTRACT

Provided are a glass body for pressure forming enabling press forming in a low-temperature range without the need of a special mold material, and a method for manufacturing the same. A glass body for pressure forming 1 having a porosified layer 1b formed by porosifying a surface thereof and having a Vickers hardness of 85 N/mm² or less on the porosified surface. The porosified layer 1b can be manufactured by phase-separating the glass body by spinodal decomposition, acid-treating the phase-separated glass body and then treating the acid-treated glass body with alkali or hot water to porosify the surface of the glass body.

### CROSS-REFERENCE TO RELATED APPLICATIONS

This application is a continuation of prior International Application No. PCT/JP2014/071482 filed on Aug. 15, 2014, which is based upon and claims the benefit of priority from Japanese Patent Applications Nos. 2013-178544 filed on Aug. 29, 2013 and 2014-144026 filed on Jul. 14, 2014; the entire contents of all of which are incorporated herein by reference.

### TECHNICAL FIELD

Embodiments of the present invention generally relate to a glass body for pressure forming whose surface shape can be easily processed by applying pressure thereto even at low temperatures such as a glass transition point (Tg) or lower and a method for manufacturing the same, and a microfabricated glass body formed by processing the glass body for pressure forming and a method for manufacturing the same.

### BACKGROUND

Conventionally, as a method for preventing reflection of incident light on an optical surface in an optical member such as a lens or a diffraction grating, there is, for example, a method of providing a two-dimensional grating (hereinafter, an antireflection grating) having a quardrangular pyramid or circular cone structure controlled to have a size smaller than a wavelength size on the optical surface.

As the method for forming the antireflection grating on the optical surface of the optical member, for example, a method for performing etching process on the optical member can be used (JP-A H09-254161(KOKAI)). This method applies a resist on a die surface, draws an original pattern corresponding to the pattern of the antireflection grating on the resist by an exposure apparatus, and then develops the original pattern to form a resist mask having a resist pattern in which a resist portion and a micro groove are repeated at intervals corresponding to those of the pattern of the antireflection grating.

Then, this method is applied to the optical member using this resist mask as an etching mask in replace of the die surface to perform etching processing, whereby a groove in an inclined shape in which the width is gradually decreased in a thickness direction due to etching of an exposed portion of the optical member is formed, and a remaining portion which has not been etched becomes the antireflection grating.

In the case where the optical surface of the optical member is a three-dimensional shape surface such as a convex lens surface or a concave lens surface, in the above-described exposure of electron beams, the electron beams are not focused on the entire resist on the optical surface, and therefore an improving method for forming the antireflection grating in a desired shape even in the three-dimensional shape surface is also known. This method is a method of forming a metal film once on the three-dimensional shape surface, anodizing the metal film to form a hole pattern composed of many micropores corresponding to a micro grating, forming a mask film of a pattern reversed from the hole pattern, and then etching the three-dimensional shape surface exposed in the micropores by etching processing to form the micro grating (JP-A 2005-257867(KOKAI)).

Besides, as the method of forming a cyclic structure on the surface of glass, a mold method is also known. The mold method is a method of heating glass and a mold to high temperatures and pressing them against each other to form a desired shape (JP-A 2009-161405 (KOKAI)). In order to form a micro shape on the glass surface having high heat resistance and chemical stability, at least a mold material not deteriorating after repeated use at a temperature of 300° C. or higher is selected and a mold made of silicon carbide is preferable as the one capable of smoothly forming the microfabrication surface, and its manufacturing method is described.

### SUMMARY

However, in the case of performing the microfabrication by etching, the processing operation is complicated such as forming a mask corresponding thereto, performing etching operation, removing the mask and so on, thus requiring much labor and leading to increased manufacturing cost.

Besides, the microfabrication by the mold method can be performed by a simple operation such as pressing a mold, but its problem is that a mold material having high resistance in processing in a high-temperature state is required and the material to be used is limited.

Hence, an object of the present invention is to provide a glass body for pressure forming enabling press forming that is easy in processing operation at the time when performing microfabrication on a glass surface even in a low-temperature range without the need of a special mold material, and a method for manufacturing the same. Another object is to provide a microfabricated glass body formed by transfer processing a projecting and recessed shape using the glass body for pressure forming, and a method for manufacturing the same.

A glass body for pressure forming of the present invention has a porosified surface, the glass body having a Vickers hardness of 85 N/mm² or less on the porosified surface.

A method for manufacturing a glass body for pressure forming of the present invention, includes: phase-separating a glass material by spinodal decomposition; and porosifying a surface of the glass material by acid-treating the phase-separated glass material and then treating the acid-treated glass material with alkali or hot water.

A microfabricated glass body of the present invention has a desired projecting and recessed shape formed by press-processing a surface of the above-described glass body for pressure forming.

A method for manufacturing a microfabricated glass body of the present invention includes: phase-separating a glass material by spinodal decomposition; porosifying a surface of the glass material by acid-treating the phase-separated glass material and then treating the acid-treated glass body with alkali or hot water; and a pressure forming step of pressing the porosified glass body by a forming die to transfer a projecting and recessed shape.

According to a glass body for pressure forming of the present invention and a method for manufacturing the same, a material can be provided whose surface shape is easily processed by press forming even without heating to high temperatures. Further, according to a microfabricated glass body of the present invention and a method for manufacturing the same, processing by press forming can be performed even without heating to high temperatures, and therefore the choice of the manufacturing conditions, material of the forming die and so on is widened, and a glass body having a desired surface shape can be efficiently manufactured.

### BRIEF DESCRIPTION OF THE DRAWINGS

FIG. 1 is a side cross-sectional view illustrating a structure region of a glass body for pressure forming of an embodiment of the present invention.

FIG. 2 is electron micrographs of a transferred pattern obtained in Example 20.

FIG. 3 is electron micrographs of transferred patterns obtained in Examples 21 to 23.

FIG. 4 is a chart illustrating the transmittance of light obtained in Example 24.

FIG. 5 is an electron micrograph of a transferred pattern obtained in Example 24.

FIG. 6 is the electron micrograph of the transferred pattern obtained in Example 24.

### DETAILED DESCRIPTION

Hereinafter, the present invention will be described in detail referring to the drawings.

[Glass Body for Pressure Forming]

A glass body for pressure forming of the present invention is characterized in that its surface is porosified and the Vickers hardness is 85 N/mm² or less on the porosified surface as described above. More specifically, by setting the surface hardness to a predetermined hardness or less, the glass body for pressure forming can be pressure-formed in a low-temperature range. In this Description, the low-temperature range means temperatures equal to or lower than a glass transition point (Tg) of glass constituting the glass body, and is preferably a range of 10 to 250° C. and more preferably 20 to 100° C., in the temperature range, for forming conditions of the pressure forming and a simpler operation. The ability of the forming near room temperatures eliminates the heating treatment and the process time for temperature control.

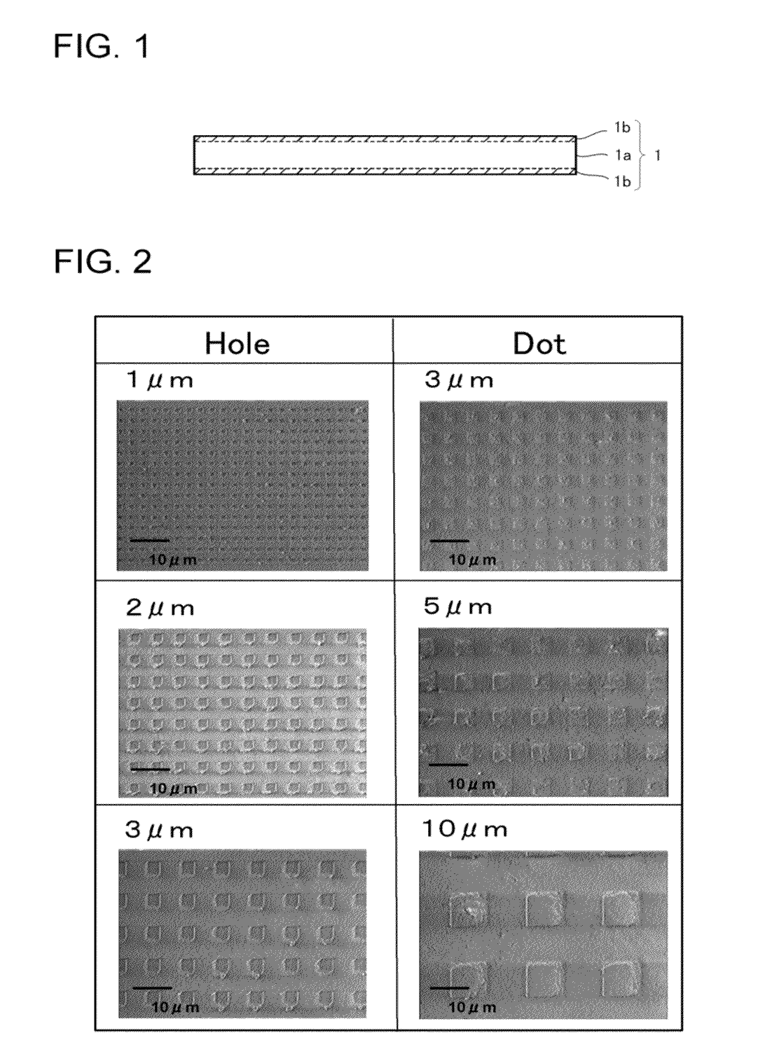

The glass body for pressure forming only needs to have the porosified surface irrespective of porosification inside the glass body, but preferably has the inside not being porosified but being normally glassy. In this case, as illustrated in FIG. 1, a glass body for pressure forming 1 is composed of a base material layer 1a that is not porosified and a porosified layer 1b porosified on the surface side, and can be divided into a non-forming region (base material layer 1a) and a forming region (porosified layer 1b; a region surrounded by broken lines with a shadowed hatching pattern) in the thickness direction. Such a configuration makes a processed portion to be deformed by pressing stay in the forming region formed on the surface side in the pressure forming, thereby making it possible to make the processed shape to be obtained homogeneous. Note that the porosified layer 1b is a layer formed by surface treatment of the glass as described later.

In this regard, setting the Vickers hardness of the porosified layer 1b to 85 N/mm² or less makes it possible to successfully transfer the forming surface shape of a forming die even by pressure forming in the low-temperature range. The Vickers hardness is preferably 80 N/mm² or less and more preferably 75 N/mm² or less. With such Vickers hardness, the projecting and recessed shape can be accurately transferred even when the transfer shape has a line width of about 0.1 μm. However, when the Vickers hardness is too low, the porosified layer may peel off after transfer and therefore the Vickers hardness of the porosified layer 1b is preferably 1.0 N/mm² or more and more preferably 3.0 N/mm² or more. Here, the Vickers hardness was the value measured according to JIS Z 2244 and was measured with a load of 100 to 200 g in measuring the Vickers hardness so that the indentation length was in a range of 50 to 300 μm.

The thickness of the porosified layer 1b only needs to be appropriately adjusted according to the transfer shape by the pressure forming and is, for example, preferably 1 μm or more, more preferably 3 to 100 μm, furthermore preferably 5 to 50 μm, and particularly preferably 10 to 30 μm.

The Vickers hardness of the porosified layer 1b and the thickness of the porosified layer 1b can be adjusted by the composition of the glass body, the phase-separation thermal treatment process conditions (temperature and time), the porosification process conditions (liquid kind, liquid composition, liquid concentration, treatment temperature, treatment time) in the manufacturing method described below.

Here, the thickness of the porosified layer 1b was measured by observing its cross section under an optical microscope. Further, when the porous layer is thin and is thus difficult to observe under the optical microscope, the thickness of the porous layer can be calculated by assuming that the thickness of the porous layer is proportional to the acid treatment time.

Besides, an example in which the porosified layer 1b is provided on both surfaces of the glass body is illustrated in FIG. 1, but the porosified layer 1b may be provided on one surface, or a partial region of the surface of the glass body may be porosified

Further, this glass body for pressure forming is preferably higher in transmittance when its application after processing is an optical application, and the transmittance at a wavelength of 400 nm to 800 nm is preferably 80% or more, more preferably 85% or more, and furthermore preferably 90% or more. Note that the transmittance in this Description is the value measured by an ultraviolet-visible-near-infrared spectrophotometer (Shimadzu Corporation, UV3101PC).

Next, a method for manufacturing a glass body for pressure forming will be described. This manufacturing method can be performed by: phase-separating the glass material by heat treatment; and porosifying the surface of the glass material by acid-treating the phase-separated glass material and then treating the acid-treated glass material with alkali or hot water. Hereinafter, the processes will be described.

First, the glass material being the material used here is not particularly limited as long as it is a glass material that can be phase-separated by spinodal decomposition, and its examples include glasses having compositions such as: a silicon oxide-boron oxide-alkali metal oxide; a silicon oxide-boron oxide-alkali metal oxide containing at least one of alkaline-earth metal oxide, zinc oxide, aluminum oxide, and zirconium oxide; a silicon oxide-phosphate-alkali metal oxide; and a silicon oxide-boron oxide-calcium oxide-magnesium oxide-aluminum oxide-titanium oxide.

Among them, the glass having a silicon oxide-boron oxide-alkali metal oxide as a matrix composition is preferable, in which the content of silicon oxide in the glass is preferably 45 to 80 mass %, more preferably 50 to 80 mass %, furthermore preferably 55 to 80 mass %, and particularly preferably 60 to 80 mass %.

The glass to be phase-separated by spinodal decomposition is glass having a phase-separation property. The phase-separation property means, in the case of a borosilicate-based glass having a silicon oxide-boron oxide-alkali metal oxide taken as an example, that the glass is phase-separated therein into a silicon oxide rich phase and an alkali metal oxide-boron oxide rich phase by the heat treatment.

Generally, the heat treatment performed on the above-described glass can phase-separate the glass. The heat treatment only needs to be set to conditions under which desired characteristics can be obtained because the phase-separated state to be formed changes according to the heating temperature and the treatment time. For example, it is preferable to perform the treatment at a heating temperature set to a range of 400 to 800° C. and in a range of 10 minutes to 100 hours, and these conditions are preferable, in particular, for the above-described borosilicate-based glass.

In manufacturing glass, for the glass which has been phase-separated at a stage of molten in melting a raw material, the above-described individual phase-separation heat treatment can be omitted because the heating in the melting includes the phase-separation heat treatment.

Then, the phase-separated glass is acid-treated, whereby the alkali metal oxide-boron oxide rich phase being an acid-soluble component is brought into contact with an acid solution and thereby dissolved and removed. The acid solution used here is not particularly limited as long as it can dissolve the above-described soluble component, and its examples include hydrochloric acid, sulfuric acid, nitric acid, hydrofluoric acid, organic acids such as acetic acid, and their combinations, and, among them, inorganic acids such as hydrochloric acid and nitric acid are preferable. The acid solution is preferably an aqueous solution, and its acid concentration only needs to be appropriately set in a range of 0.1 to 2.0 mol/L (0.1 to 2.0 normality). In this acid treatment, the temperature of the solution only needs to be set to a range of room temperatures to 100° C. and the treatment time only needs to be set to about 10 minutes to 5 hours.

Then, a cleaning treatment with at least one of an alkaline solution and hot water to the acid-treated glass is performed. This cleaning treatment is performed for the purpose of dissolving and removing the residue caused by the acid treatment. Note that in this event, hydrolysis or the like removes silicon oxide to promote porosification, and therefore the cleaning treatment can also be used for adjusting the degree of porosification. In particular, the alkaline solution is effective in adjusting the degree of porosification, whereas the hot water is effective in dissolving and removing the residue. Accordingly, in the case of performing both of the alkaline solution treatment and the hot water treatment, it is preferable to perform the hot water treatment after the alkaline solution treatment is performed. Performing the hot water treatment after the alkaline solution treatment effectively removes the residue after etching to enable improvement in transmittance of the glass body.

The alkali used here, whose examples include alkaline solutions of sodium hydroxide, potassium hydroxide, tetramethylammonium hydroxide, and ammonia, is preferably an alkaline aqueous solution. For the cleaning treatment with alkali, an alkali concentration of the alkaline solution only needs to be appropriately set in a range of 0.1 to 2.0 mol/L (0.1 to 2.0 normality). This alkali treatment is preferably performed at a temperature of the solution of 10 to 60° C. and in a treatment time set to 5 to 60 minutes.

Besides, it is preferable that pure water with less impurities or the like heated to 50 to 90° C. is used as the hot water, and its treatment time is 5 to 60 minutes.

Here, it is only necessary to perform one of the treatment with the alkaline solution and the treatment with the hot water, but both of them may be performed. Further, it is preferable to perform these treatments always after the acid treatment is performed, and it is preferable to perform “acid treatment-alkali or hot water treatment” as a set.

The acid treatment-alkali or hot water treatment is performed as described above, whereby an acid-dissolved portion formed by phase-separation by spinodal decomposition is dissolved by the acid treatment to form into a hole, and the hole is formed as a continuous hole continuing with an almost equal hole diameter from the surface to the inside.

Depending on the treatment time of this acid treatment-alkali or hot water treatment, a region of the glass body to be porosified is changed, and performing the treatments for a longer time can make a layer of the porosified surface deeper. The depth of the porosified layer is preferably 5 to 100 μm from its surface as described above, and the treatment conditions only need to be appropriately changed for a desired depth.

Besides, depending on the phase-separation conditions and the treatment time of the acid treatment-alkali or hot water treatment, the Vickers hardness of the glass body on the surface changes. Optimal phase-separation conditions depend on the glass composition, and for finding the optimal phase-separation conditions, it is effective, for example, to examine a T-T-T curve. Advancing the phase separation in a temperature range lower by, for example, about 100° C. than a temperature range where the phase separation is most likely to advance that is found from the T-T-T curve, makes it possible to make the hole diameter smaller and decrease the Vickers hardness. Performing each of the acid treatment-alkali or hot water treatment for a long time tends to decrease the Vickers hardness, so that the phase-separation conditions and the treatment conditions of the acid treatment-alkali or hot water treatment only need to be appropriately changed for the above described range of the Vickers hardness.

A microfabricated glass body of the present invention is a glass body with a desired projecting and recessed shape formed by processing the surface of the above-described glass body for pressure forming. This process-forming is obtained by pressing a forming die against the surface of the glass body for pressure forming and transferring the forming surface shape of the forming die to the surface of the glass body for pressure forming by applying pressure thereto.

The microfabricated glass body is high in transfer accuracy even if the processing shape to be formed is micro, and is therefore can be obtained as an elaborate processed glass body. The projection and recess in the processing shape can be manufactured to have a line width or a length of one side of 0.1 μm to 5.0 mm, and preferably includes a line width or a length of one side of 0.2 to 100 μm.

Note that the processing shape to be formed can be any shape. Further, when it is desired to impart functionality to the glass body, it is also possible to process the glass body into a micro shape exhibiting the functionality. Examples of the functionality which can be imparted here include an optical function, a physical function and so on described below.

Imparting the optical function to the glass body can be achieved, for example, by forming the forming die having a micro cyclic structure in which the projecting shape is cyclically formed on the forming surface. This cycle is not limited but only needs to be formed into a shape according to the purpose of glass to be formed. This can be obtained by forming, for example, as described in JP-A 2009-161405(KOKAI), the forming surface shape of the forming die in a recessed shape and transferring this shape to the glass body for pressure forming by press forming. This recessed shape only needs to have a cycle of the recessed portion of about 50 nm to 300 nm when used, for example, for the purpose of a polarizer, a wavelength plate, an antireflection plate or the like used in a region of a wavelength of 400 nm to 800 nm, and to have a cycle of the recessed portion of about 300 nm to 15 μm for forming a diffraction grating.

The depth of the recessed portion is not particularly limited but only needs to be set to about 10 nm to 1000 nm when used, for example, for the purpose of a polarizer, a wavelength plate, an antireflection plate or the like, and the depth of the recessed portion only needs to be set to about 100 nm to 20 μm for forming a diffraction grating.

Besides, for imparting the physical function to the glass body, for example, a projecting and recessed structure is formed and then a fluorine-based water repellent film is formed by applying on its surface by dip coating or spin coating, whereby super water-repellent glass can be obtained which is significantly high in water repellent property as compared to the case of performing a water repellent treatment on the flat surface.

Next, a method for manufacturing a microfabricated glass body will be described. This manufacturing method can be achieved by the same operation as that of a publicly-known press forming and has features, in the present invention, in that the glass can be easily formed with the temperature in pressing set to the glass transition point (Tg) or lower.

In other words, this microfabricated glass body is formed such that by pressing the forming die against the above-described glass body for pressure forming and applying pressure to them, the forming surface shape of the forming die is easily transferred to a porous portion on the glass body surface. The forming can be easily achieved by a simple operation without the necessity of heating the glass to a high temperature equal to or higher than the glass transition point (Tg) unlike the conventional press forming.

The pressure in applying pressure is preferably set, for example, to 5 to 60 N/mm² though depending on the Vickers hardness of the surface of the glass body for pressure forming. In this event, the high-temperature heating as described above is unnecessary but the temperature only needs to be equal to or lower than the glass transition point (Tg) of the glass used, and is preferably about 5 to 40° C. and furthermore preferably a temperature of about room temperatures (25° C.). If it is unnecessary to perform the high-temperature heating as described above, an apparatus for maintaining the high-temperature state is unnecessary and even a simple manufacturing apparatus can cope with the forming, resulting in reduced cost. Besides, the operation at high temperatures is accompanied by early deterioration of the members such as the forming die whose time for replacement is short. However, the use at high-temperature conditions can be avoided in the invention of this application to suppress the deterioration, so that the usable life of the forming die is increased and the cost can be reduced also in that point.

### EXAMPLES

Hereinafter, the present invention will be concretely described using Examples, and the present invention should not be limited by the description of them.

[Fabrication of a Glass Plate]

### Reference Example

Particles of SiO₂, H₃BO₃, Na₂CO₃ being raw materials were mixed together so that the contents in terms of oxides to be obtained were 65 mol %, 27.0 mol %, and 8.0 mol % and stirred to obtain mixed particles. The mixed particles were put into a platinum crucible heated to 1500° C. dividedly in three times every 10 minutes, and stirred for 60 minutes after all the raw materials were put thereinto to thereby mix together for homogenization. An obtained solution was formed into a plate shape and slowly cooled, whereby a glass plate was obtained. The glass plate was subjected again to a heat treatment (phase-separation thermal treatment).

The phase-separation thermal treatment was performed under the following two conditions. A phase-separation thermal treatment (1) was performed such that the glass plate was kept at 400° C. for 30 minutes, then increased in temperature up to 575° C. in 17.5 minutes and kept at this temperature for 2 hours, and then decreased in temperature down to 20° C. in 555 minutes. A phase-separation thermal treatment (2) was performed such that the glass plate was kept at 400° C. for 30 minutes, then increased in temperature up to 600° C. in 20 minutes and kept at this temperature for 2 hours, and then decreased in temperature down to 20° C. in 580 minutes. The glass obtained in the phase-separation thermal treatment (1) is regarded as glass 1, and the glass obtained in the phase-separation thermal treatment (2) is regarded as glass 2. From two kinds of glass plates which have been subjected to phase-separation thermal treatment, glass materials each being 1.2 cm×1.2 cm×1.0 mmt and having both surfaces being mirror surfaces were obtained by grinding and polishing.

[Manufacture of the Glass Body for Pressure Forming and a Microstructure Glass Body]

### Example 1 to Example 19

To the glass plates obtained in the above Reference Example, the acid treatment using 1 mol/L of a nitric acid aqueous solution, the alkali treatment using 1 mol/L of a sodium hydroxide aqueous solution, and the hot water treatment using heated pure water at 60° C. were performed by immersing the glass plates in the solutions and hot water. Note that the glass plates used here and the treatment time of each of the treatments were as those listed in Table 1. Besides, the Vickers hardness and imprintability of the surfaces of the obtained glass plates were also examined. In Table 1, Examples 2 to 7, Examples 10 to 15, and Examples 18 to 19 are Examples, and Examples 8 to 9 and Examples 16 to 17 are Comparative Examples.

TABLE 1

| | | Phase-separation | | | Hot | | |
|---|---|---|---|---|---|---|---|
| | | treatment | Acid | Alkali | water | Vickers | |
| Example | Use | temperature | treatment | treatment | treatment | hardness | |
| number | glass | (° C.) | (min) | (min) | (min) | (N/mm²) | Imprintability |
| 1 | Glass 1 | 575 | 30 | 0 | 0 | 91.1 | no good |
| 2 | Glass 1 | 575 | 30 | 15 | 0 | 50.5 | good |
| 3 | Glass 1 | 575 | 30 | 15 | 15 | 40.0 | good |
| 4 | Glass 1 | 575 | 30 | 30 | 0 | 50.2 | good |
| 5 | Glass 1 | 575 | 30 | 30 | 15 | 24.6 | good |
| 6 | Glass 1 | 575 | 30 | 60 | 0 | 21.0 | good |
| 7 | Glass 1 | 575 | 30 | 60 | 15 | 3.3 | good |
| 8 | Glass 1 | 575 | 10 | 0 | 0 | 89.1 | no good |
| 9 | Glass 1 | 575 | 10 | 0 | 15 | 94.6 | no good |
| 10 | Glass 1 | 575 | 10 | 15 | 0 | 39.1 | good |
| 11 | Glass 1 | 575 | 10 | 15 | 15 | 52.8 | good |
| 12 | Glass 1 | 575 | 10 | 30 | 0 | 46.1 | good |
| 13 | Glass 1 | 575 | 10 | 30 | 15 | 37.1 | good |
| 14 | Glass 1 | 575 | 10 | 60 | 0 | 33.6 | good |
| 15 | Glass 1 | 575 | 10 | 60 | 15 | 31.7 | good |
| 16 | Glass 2 | 600 | 10 | 0 | 0 | 156.6 | no good |
| 17 | Glass 2 | 600 | 10 | 10 | 0 | 94.6 | no good |
| 18 | Glass 2 | 600 | 10 | 20 | 0 | 46.4 | good |
| 19 | Glass 2 | 600 | 10 | 10 | 10 | 51.4 | good |

Here, characteristics were evaluated as follows.

[Vickers hardness]: Measured and calculated according to JIS Z 2244. The Vickers hardness was measured with a load of 100 to 200 g at the time when measuring so that the indentation length was in a range of 50 to 300 μm.

[Imprintability]: Evaluated by the transfer property at the time when press-forming the glass plate in each example at room temperatures. An imprint mold made of quartz of 10 mm×10 mm×1.0 mmt in a square shape was imprinted on the glass plate in each example at a strength of 10 N/mm², and an example in which the structure of the imprint mold was transferred was “good” and an example in which the transfer of the structure could not be confirmed was “no good.” The presence or absence of transfer of the structure was confirmed under a scanning electron microscope.

### Example 20

The acid treatment and the alkali treatment of immersing the glass 1 in 1 mol/L of a nitric acid aqueous solution for 1 minute and then immersing the glass 1 in 1 mol/L of a sodium hydroxide aqueous solution were repeated alternately 10 times, to manufacture a glass plate for pressure forming having a surface porosified. The glass body for pressure forming was press-formed at room temperatures (25° C.), 1.2 kN/cm² for 60 seconds using a forming die in a plate shape of 10 mm×10 mm×0.6 mmt in a square shape. On the forming surface of the forming die used here, four transfer regions in which L&S (Line & Space), Dot, Hole patterns are formed are formed with the same size and the same pattern. Each pattern is formed such that the line width or the length of one side has a plurality of lengths of 1 μm, 2 μm, 3μm, 5μm, and 10 μm.

A part of electron micrographs of the patterns transferred to the glass plate in this event were shown in FIG. 2. Here, “Dot” is the pattern where the forming surface having dots with one side of 3 to 5 μm are transferred and holes are formed, and “Hole” is the pattern where the forming surface having holes with one side of 1 μm to 3 μm are transferred and dots are formed. Further, the depth of the pattern is 1 μm.

### Example 21 to Example 23

The mixed particles prepared to have the same composition as that of Reference Example were subjected to temporary sintering at 750° C. for 30 minutes and then grinding repeatedly twice, to baking at 1500° C. for 20 minutes, to drawing out and cooling and solidifying, then to grinding, further to baking at 1500° C. for 20 minutes, and then to drawing out, whereby a glass plate of 15 mm×20 mm×1.0 mmt was produced.

The glass plate was subjected to the phase-separation thermal treatment at 575° C. for 1 hour and then decreased in temperature down to room temperatures (25° C.) in 5 hours, whereby a glass plate (glass 3) was obtained. Then, the acid treatment and the alkali treatment of immersing the obtained glass 3 in 1 mol/L of a nitric acid aqueous solution for minute and then immersing the glass 3 in 1 mol/L of a sodium hydroxide aqueous solution were repeated alternately 10 times, to manufacture a glass plate for pressure forming having a surface porosified.

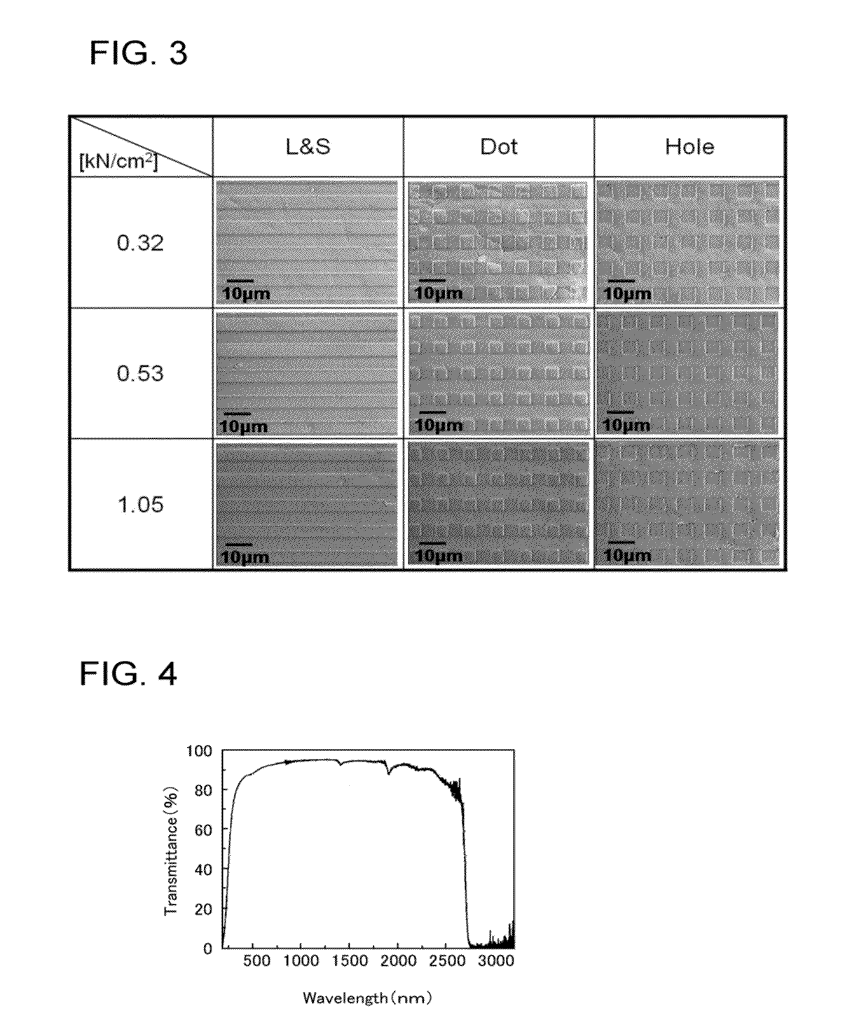

The obtained glass plate for pressure forming was subjected to the same press forming using the same forming die as that in Example 20 except that the forming pressure was set to 0.32 kN/cm² (Example 21), 0.53 kN/cm² (Example 22), and 1.05 kN/cm² (Example 23), whereby the pattern on the forming surface was transferred. Electron micrographs of patterns having a width or one side of 5 μm were shown in FIG. 3.

### Example 24

The glasses 3 fabricated in Examples 21 to 23 were immersed in 1 mol/L of a nitric acid aqueous solution for 15 minutes and then immersed in 1 mol/L of a sodium hydroxide aqueous solution for 10 minutes, further immersed in the hot water at 60° C. for 15 minutes, whereby glass plates for pressure forming having surfaces porosified were manufactured. The result of measuring the transmittance at a wavelength of 200 nm to 3200 nm of the obtained glass plates for pressure forming was illustrated in FIG. 4. The transmittance in a wavelength region of a wavelength of 400 nm to 800 nm was successfully 85% or more in the whole range. Note that the transmittance was measured by an ultraviolet-visible-near-infrared spectrophotometer (Shimadzu Corporation, UV3101PC).

The above-described glass body for pressure forming was press-formed at room temperatures (25° C.), 1.2 kN/cm² for 60 seconds using a forming die in a plate shape of 10 mm×10 mm×0.6 mmt in a square shape. On the forming surface of the forming die used here, L&S (Line & Space) having a width of 1 μm are formed.

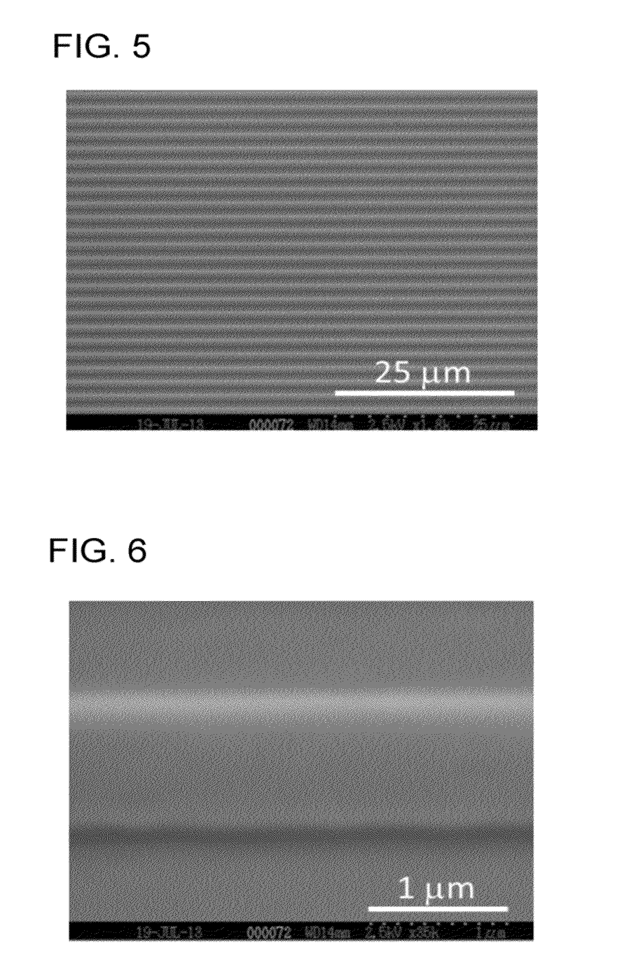

A part of an electron micrograph of the pattern transferred to the glass plate in this event was shown in FIG. 5 and FIG. 6. L&S having the same width of 1 μm as that of the mold is formed, which shows that the transfer accuracy is excellent. Note that FIG. 6 is a partially enlarged view of FIG. 5.

As described above, the glass body for pressure forming of the present invention can be pressure-formed even at room temperatures and the shape of the forming die can be accurately transferred thereto, so that a glass body using a desired surface shape can be easily manufactured.

According to the present invention, it is possible to provide a glass body for pressure forming which can be pressure-formed even in a low-temperature range such as room temperatures. Further, it is also possible to provide a microfabricated glass body having a desired projecting and recessed shape by pressure-forming the glass body for pressure forming.

What is claimed is:

1. A glass body for pressure forming having a porosified surface, the glass body having a Vickers hardness of 85 N/mm² or less on the porosified surface.

2. The glass body for pressure forming according to claim 1,
wherein a depth of a layer of the porosified surface is 1 μm or more.

3. The glass body for pressure forming according to claim 1,
wherein a shape of the glass body is a plate shape.

4. The glass body for pressure forming according to claim 1,
wherein a transmittance at a wavelength of 400 nm to 800 nm of the glass body is 80% or more.

5. A method for manufacturing a glass body for pressure forming, comprising:
phase-separating the glass material by spinodal decomposition; and
porosifying a surface of the glass material by acid-treating the phase-separated glass material and then treating the acid-treated glass material with alkali or hot water.

6. The method for manufacturing a glass body for pressure forming according to claim 5,
wherein after the acid treatment, the alkali treatment is performed, and thereafter the hot water treatment is performed.

7. A microfabricated glass body having a desired projecting and recessed shape formed by press-processing a surface of the glass body for pressure forming according to claim 1.

8. The microfabricated glass body according to claim 7,
wherein a line width or one side of the projecting and recessed shape is 0.1 to 100 μm.

9. The microfabricated glass body according to claim 7,
wherein the projecting and recessed shape formed on a surface of the microfabricated glass body has an optical function.

10. The microfabricated glass body according to claim 7,
wherein the projecting and recessed shape formed on a surface of the microfabricated glass body has a physical function.

11. A method for manufacturing a microfabricated glass body, comprising:
phase-separating a glass material by spinodal decomposition;
porosifying a surface of the glass material by acid-treating the phase-separated glass material and then treating the acid-treated glass material with alkali or hot water; and
pressing the porosified glass material by a forming die to transfer a projecting and recessed shape.

12. The method for manufacturing a microfabricated glass body according to claim 11,
wherein a line width or one side of the projecting and recessed shape is 0.1 to 100 μm.

13. The method for manufacturing a microfabricated glass body according to claim 11,
wherein the press of the porosified glass is performed at a temperature equal to or lower than a glass transition point (Tg) of the glass material.
